(19) United States
(12) Patent Application Publication
(10) Pub. No.: US 2005/0088340 A1
(43) Pub. Date: Apr. 28, 2005

(54) GPS/DAB and GSM hybrid antenna array

(75) Inventors: Sheng Ming Deng, Hsinchu City (TW); Jungchou Kao, Hsinchu City (TW)

Correspondence Address: BRUCE H. TROXELL, SUITE 1404, 5205 LEESBURG PIKE, FALLS CHURCH, VA, 22041, US

(73) Assignee: Inpaq Technology Co., Ltd.

(21) Appl. No.: 10/689,585

(22) Filed: Oct. 22, 2003

(51) Int. Cl. H01Q 1/36

(52) U.S. Cl. 343/700 MS; 343/895

(57) ABSTRACT

An innovative GPS/DAB and GSM hybrid antenna array is composed of an entrainer for entraining a PCB or other electric circuit boards, a GPS/DAB ceramic patch antenna entrained on a surface of the entrainer; a low noise amplifier (LNA) entrained on the other surface thereof, and an antenna for global system mobile communication (GSM). By forming the GSM antenna into a planar thin strip configuration, the height and size of this hybrid antenna array can be greatly reduced, and fabrication cost of the same can also be cut down.

### BACKGORUND OF THE INVENTION

1. Field of the Invention

The present invention relates to a GPS/DAB and GSM hybrid antenna array, and more particularly, to a planar thin strip. GPS/DAB and GSM (Global System for Mobile) communication hybrid antenna array which can reduce the height, and minimize the fabrication cost of the antenna array.

2. Description of the Prior Art

At present, either a GPS/DAB (Global Positioning System), or a GSM communication system for vehicle has to be associated with an antenna array.

FIG. 1 is a schematic view of a conventional GPS/DAB conventional hybrid antenna array. As shown in FIG. 1, this conventional antenna array consists of an entrainer 100, a GPS/DAB antenna 200 entrained on the entrainer 100, a low noise amplifier (LNA) 300, and a GSM antenna 400. In this hybrid antenna array, the entrainer 100 is for entraining a printed circuit board (PCB) or other electric circuit boards. The GPS/DAB antenna 200 is a ceramic patch type antenna, and GSM antenna 400 is a wound type antenna. For minimizing the height and the occupied area of the antenna as low and compact as possible, LNA 300 is placed on the entrainer's 100 surface beneath the GPS/DAB antenna 200, and two coaxial connecting wires are extended out between the GPS/DAB ceramic block antenna 200 and the LNA 300, and from the GSM antenna 400 respectively. If the aforesaid entrainer 100 is not electrically conductive, two electrically conductive films 201 and 301 are intercalated between the entrainer 100 and the LNA 300 respectively.

However, the conventional GPS/DAB and GSM hybrid antenna array constructed as such has the following inherent disadvantages:
1. The straightly erected wound type GSM antenna causes the height of the antenna array excessively tall.
2. The excessively tall antenna array makes the whole unit bulky and inconvenient to use.

In order to rectify the above-mentioned disadvantages inherent to the conventional techniques, the inventor has endeavored for years by continuous research and experimentation attempting to find out the remedies for such disadvantages, and at last has succeeded in realizing the present invention.

### SUMMARY OF THE INVENTION

Accordingly, it is an object of the present invention to provide a short status and compact sized GPS/DAB and GSM hybrid antenna array.

It is another object of the present invention to provide a GPS/DAB and GSM hybrid antenna array which can be fabricated with a low cost yet will not spoil the appearance of the vehicle on which it is installed.

To achieve the above objects, the GPS/DAB and GSM hybrid antenna array of the present invention comprises an entrainer for entraining a PCB or other electric circuit boards, a GPS/DAB ceramic patch antenna entrained on a surface of the entrainer, a low noise amplifier (LNA) entrained on the other surface of the entrainer opposite to GPS/DAB ceramic patch antenna, and an antenna for global system mobile communication (GSM). By forming the GSM antenna into a planar thin strip configuration, the height and size of the hybrid antenna array of the present invention is greatly reduced, and the fabrication cost of the same is also cut down.

### BRIEF DESCRIPTION OF THE DRAWINGS

For fuller understanding of the nature and objects of the invention, reference should be made to the following, detailed description taken in conjunction with the accompanying drawings in which:

FIG. 1 is a schematic view of a conventional GPS/DAB and GSM hybrid antenna array;

FIG. 2 is a three dimensional view of the GPS/DAB and GSM hybrid antenna array according to the present invention;

FIG. 3 is a schematic view illustrating another embodiment of the present invention; and

FIG. 4A˜FIG. 4E are the schematic views illustrating some other embodiments of the present invention.

### DETAILED DESCRIPTION OF THE PREFERRED EMBODIEMNTS

The construction and disadvantages about the conventional GPS/DAB and GSM hybrid antenna array have been described with reference to FIG. 1 already hence will not be repeated hereinafter.

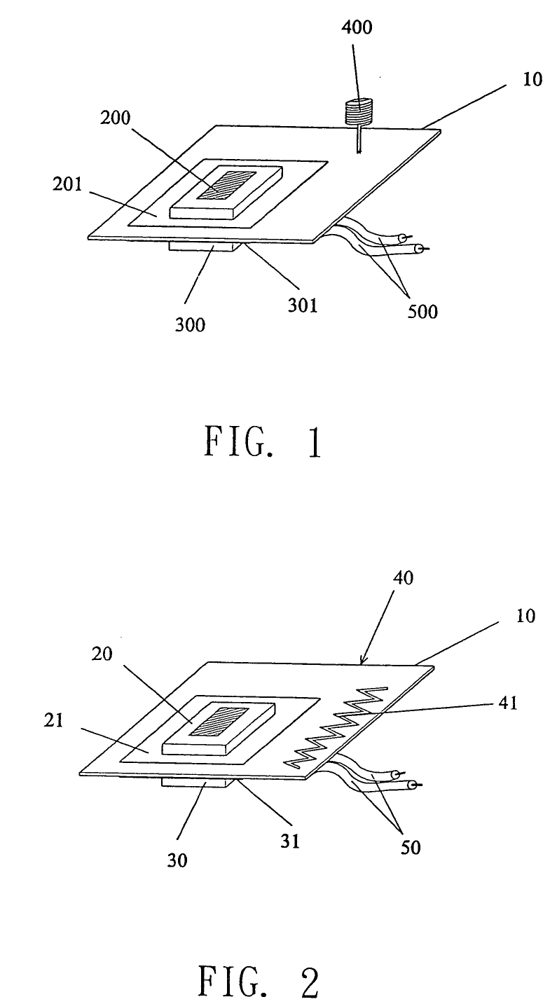

Referring to FIG. 2, this is a schematic view of the GPS/DAB and GSM hybrid antenna array according to the present invention. As shown in FIG. 2, the antenna array of the present invention comprises an entrainer 10 for entraining a PCB or other electric circuit boards, a GPS/DAB ceramic patch antenna 20 entrained on a surface of the entrainer 10, a low noise amplifier (LNA) 30 entrained on the other surface of the entrainer 10 opposite to the patch antenna 20, and an antenna for global system mobile communication (GSM) 40. If the entrainer 10 is not electrically conductive, electrically conductive films 21 and 31 are intercalated between the entrainer 10 and the GPS/DAB ceramic patch antenna 20, and between the entrainer 10 and the LNA 30 respectively. The GSM antenna 40 is formed of a planer long thin strip conductor 41 configurated in a continuous wave form directly disposed on the entrainer 10.

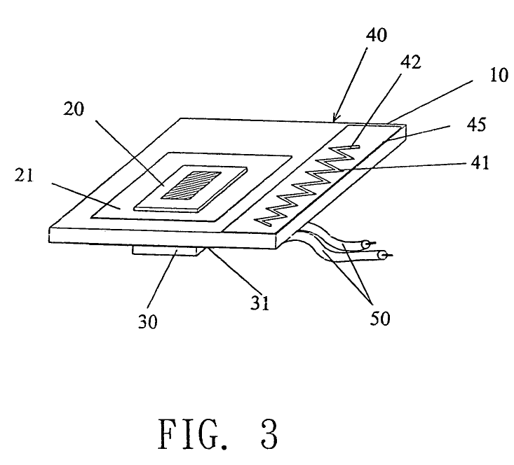

Alternatively, in another embodiment shown in FIG. 3, a wave form antenna conductor 42 is formed on a thin plate 45 by printing or by other processes and after that the thin plate 45 is attached to the surface of the entrainer 10.

A variety of structural forms for the GSM planar type antennas are available in several other embodiments of the present invention.

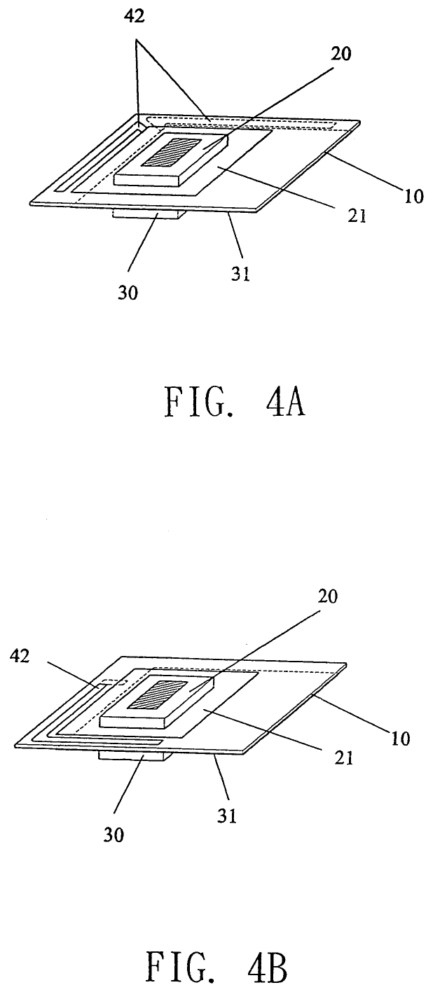

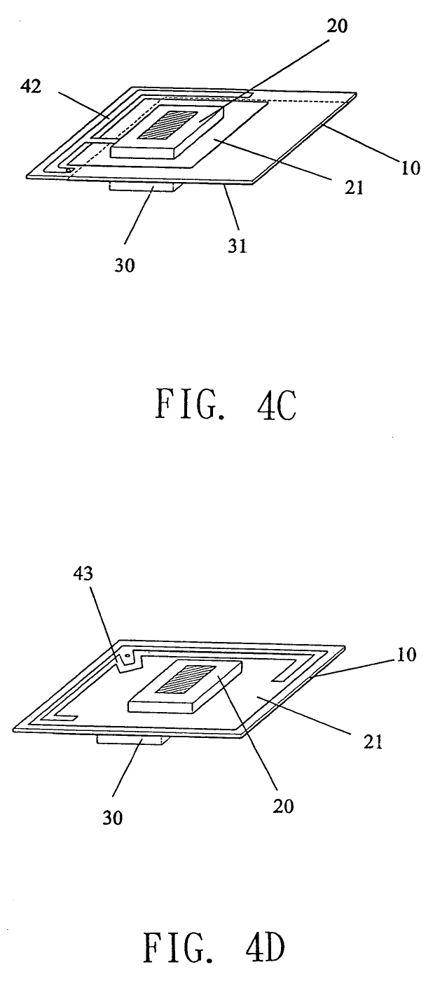

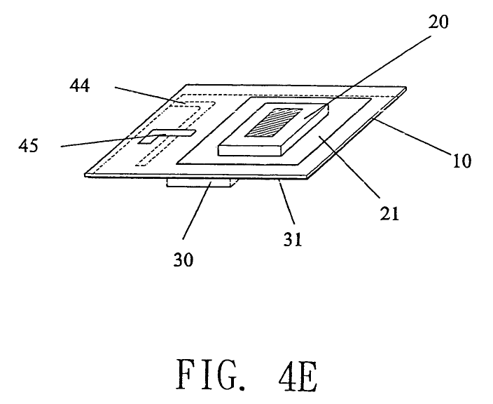

FIG. 4A shows a printed dipole antenna, it can be clearly observed that a GSM antenna conductor 42 is configurated in a printed planar double belt conductor to form a dipole antenna. The input is fed into one terminal of the dipole antenna via a micro strip line, the other end of the antenna is connected to the conductive film 31.

The preferable printed monopole antenna is shown in FIG. 4B. As shown in FIG. 4B, the monopole antenna 42 is configurated in L shape with one terminal only.

Another type of printed monopole antenna 42 is shown in FIG. 4C. As shown in FIG. 4C, the antenna 42 is configurated in L shape and serves as a resonator, while the input impedance is determined by the feeding point.

FIG. 4D shows a schematic view of a slot dipole antenna. This slot dipole antenna is preferably formed of two sections of L shaped slot facing against each other on the conductive film 21 between the GSP/DAB ceramic patch antenna 20 and the entrainer 10.

FIG. 4E shows a slot monopole antenna 44, this antenna 44 is preferably formed on a grounded conductive film 31 between the LNA 30 and the entrainer 10. It is observed that a breach is formed on an open slot at the edge of the entrainer 10. With this structure, a micro strip line 45 is required for the entrainer 10 to serve as a feeder.

In addition to the above mentioned examples, it may be considered that all of the planar antennas are applicable to the GPS/DAB and GSM planar antenna array structure. In general, GSM antenna is located at the edge of the planar entrainer, and GPS/DAB antenna is located at the center portion of the entrainer. With such an arrangement, the GPS/DAB antenna can be operated to receive signals from a satellite, while the planer thin plate GSM antenna located at the edge of the entrainer can be easily used to receive and transmit signals of an on-ground base station.

For practical applications in a complicated environmental condition, the GPS/DAB and GSM hybrid antenna array of the present invention, the planar GSM antenna 40 is suitable for use in a mobile communication system (other examples as CDMA, PCS, AMP, etc.), and the height of the entire unit of the hybrid antenna array is greatly lowered. As a result, it will not spoil the appearance of the vehicle on which this antenna array is attached, also the fabrication cost of the same is possible to cut down.

Those who are skilled in the art will readily perceive how to modify the invention. Therefore, the appended claims are to be construed to cover all equivalent structures which fall within the true scope and spirit of the invention.

1. A GPS/DAB and GSM hybrid antenna array comprising:
an entrainer for entraining a printed circuit board (PCB) or other electric circuit boards:
a GPS/DAB ceramic patch antenna entrained on a surface of said entrainer;
a low noise amplifier (LNA) entrained on the other surface of said entrainer opposite to said GPS/DAB ceramic patch antenna; and
an antenna for global system mobile communication (GSM) entrained on said entrainer;
wherein said GSM antenna is formed into a planar thin strip type.

2. The hybrid antenna array as in claim 1, wherein said GSM antenna is formed of a long planar thin strip conductor configurated in a continuous wave form directly disposed on said entrainer.

3. The hybrid antenna array as in claim 1, wherein said long planar thin strip conductor configurated in a continuous wave form is formed on a thin plate by printing or other processes and after that said thin plate is attached to the surface of said entrainer.

4. The hybrid antenna array as in claim 1, wherein an electrically conductive film is intercalated between said entrainer and said GPS/DAB ceramic patch antenna.

5. The hybrid antenna array as in claim 2, wherein an electrically conductive film is intercalated between said entrainer and said GPS/DAB ceramic patch antenna.

6. The hybrid antenna array as in claim 3, wherein an electrically conductive film is intercalated between said entrainer and said GPS/DAB ceramic patch antenna.

7. The hybrid antenna array as in claim 4, wherein said GSM planar antenna entrained on said entrainer is a printed dipole antenna.

8. The hybrid antenna array as in claim 4, wherein said GSM planar antenna entrained on said entrainer is a printed monopole antenna.

9. The hybrid antenna array as in claim 7, wherein said GSM planar antenna is split into two sections formed on two opposite surfaces of said entrainer respectively.

10. The hybrid antenna array as in claim 4, wherein said GSM planar antenna is a slot dipole antenna formed of two sections of L shaped slot facing against each other on a conductor film which being intercalated between said GPS/DAB ceramic patch antenna and said entrainer.

11. The hybrid antenna array as in claim 8, wherein said GSM planar antenna is formed on a grounded conductive film which being intercalated between said LNA and said entrainer, a breach is formed on an open slot located at the edge of said entrainer.
